(19) United States
(12) Patent Application Publication
(10) Pub. No.: US 2014/0237024 A1
(43) Pub. Date: Aug. 21, 2014

(54) NETWORK COMMUNICATION DEVICES AND FILE TRACKING METHODS THEREOF

(71) Applicant: Acer Incorporated, New Taipei City (TW)

(72) Inventors: Yu-Jen Chen, New Taipei City (TW); Chun-Hua Lee, New Taipei City (TW); Hsin-Yuan Peng, New Taipei City (TW)

(73) Assignee: Acer Incorporated, New Taipei City (TW)

(21) Appl. No.: 14/159,122

(22) Filed: Jan. 20, 2014

(30) Foreign Application Priority Data
Feb. 19, 2013 (TW) 102105686

(51) Int. Cl. H04L 12/751; H04L 29/08

(52) U.S. Cl. CPC H04L 45/026; H04L 67/02
USPC 709/203

(57) ABSTRACT

In a network communication device, a communication module provides network access to a cloud server storing an electronic file, a storage module stores the electronic file in sync with the cloud server and program code of an operating system and a file tracking system, and a processing unit loads and executes the program code to enable operations of the operating system and the file tracking system, including: generating file-modification messages corresponding to events in response to the electronic file in the storage module being moved, obtaining file features and a GUID for each of the events according to the corresponding file-modification message, determining correlations between the events according to the obtained file features and GUIDs, and determining whether to notify the cloud server to update the file path of the electronic file in the cloud server with a move event according to the correlations.

### CROSS REFERENCE TO RELATED APPLICATIONS

This application claims priority of Taiwan Patent Application No. 102105686, filed on Feb. 19, 2013, the entirety of which is incorporated by reference herein.

### BACKGROUND OF THE INVENTION

1. Field of the Invention

The invention generally relates to cloud-syncing technology, and more particularly to object features based file tracking systems for managing/monitoring file paths and movements of electronic files, so as to keep electronic files in sync between user devices and cloud servers.

2. Description of the Related Art

With rapid developments in ubiquitous computing and networking, cloud service (also called cloud computing) technologies have been developed for coordinating distributed and remote computing devices to provide various services and resources to users. For example, a user may use a desktop Personal Computer (PC), notebook PC, panel PC, smart phone, or any device capable of network communications, to access remote servers for retrieving his/her email, or to send computation requests to be handled by remote servers. In addition, remote servers may provide data backup servers and cloud-access services, and thus may be referred to as so-called cloud servers. Alternatively, with cloud service technologies, users may establish their own personal clouds for private use. For example, when a user is not at his/her house or office, he/she may always use any device capable of network communication to access the data stored in his/her home or office devices which may be referred to as the user's cloud servers. That is, users may store the same data distributed among devices that are installed at different locations, to improve the flexibility of data management and reliability of data storage, and to reduce the size limits of data storage in handheld devices.

However, for an electronic file which is stored in sync between a user device and a cloud server, when the user moves the electronic file in the user device, the operating system of the user device will take the movement of the electronic file as a combination of a delete event and a create event. Correspondingly, the cloud server will be notified of an electronic file being deleted and another electronic file being created, causing the movement of the electronic file to be separated into two independent events. As a result, the cloud server cannot correctly track the electronic file stored in sync with the user device, and inconveniences concerning file syncing between the user device and the cloud server may occur. For example, the user may mistakenly determine that the original electronic file has been deleted without being aware that another newly created electronic file is the original electronic file, and thus may attempt to upload the original electronic file to the cloud server again.

### BRIEF SUMMARY OF THE INVENTION

In order to solve the aforementioned problem, the invention proposes network communication devices and file tracking methods for tracking file paths and movements of electronic files.

In one aspect of the invention, a network communication device is provided. The network communication device comprises a communication module, a storage module, and a processing unit. The communication module is configured to provide network access to a cloud server storing at least one electronic file. The storage module is configured to store program code of an operating system and a file tracking system, and store the electronic file in sync with the cloud server. The processing unit is configured to load and execute the program code to enable operations of the operating system and the file tracking system. The operations of the operating system comprise: generating a plurality of first file-modification messages corresponding to a plurality of first events in response to the electronic file in the storage module being moved. The operations of the file tracking system comprise: obtaining a plurality of file features and a Globally Unique Identification (GUID) for each of the first events according to the corresponding first file-modification message, determining correlations between the first events according to the obtained file features and GUIDs, and determining whether to notify the cloud server via the communication module to update a file path of the electronic file in the cloud server with a move event according to the determined correlations.

In another aspect of the invention, a file tracking method for a network communication device to manage at least one electronic file in sync with a cloud server is provided. The file tracking method comprises the steps of: generating, by an operating system of the network communication device, a plurality of first file-modification messages corresponding to a plurality of first events in response to the electronic file in the network communication device being moved; obtaining a plurality of file features and a GUID for each of the first events according to the corresponding first file-modification message; determining correlations between the first events according to the obtained file features and GUIDs; and determining whether to notify the cloud server to update a file path of the electronic file in the cloud server with a move event according to the determined correlations.

Other aspects and features of the invention will become apparent to those with ordinary skill in the art upon review of the following descriptions of specific embodiments of the network communication devices and the file tracking methods.

### BRIEF DESCRIPTION OF DRAWINGS

The invention can be more fully understood by reading the subsequent detailed description and examples with references made to the accompanying drawings, wherein:

FIG. 1 is a block diagram illustrating a cloud computing environment according to an embodiment of the invention;

FIG. 2 is a block diagram illustrating the system architecture of a network communication device according to an embodiment of the invention;

FIG. 3 is a flow chart illustrating the file tracking method according to an embodiment of the invention; and

FIGS. 4A and 4B show a schematic diagram illustrating the operation of the file tracking system according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

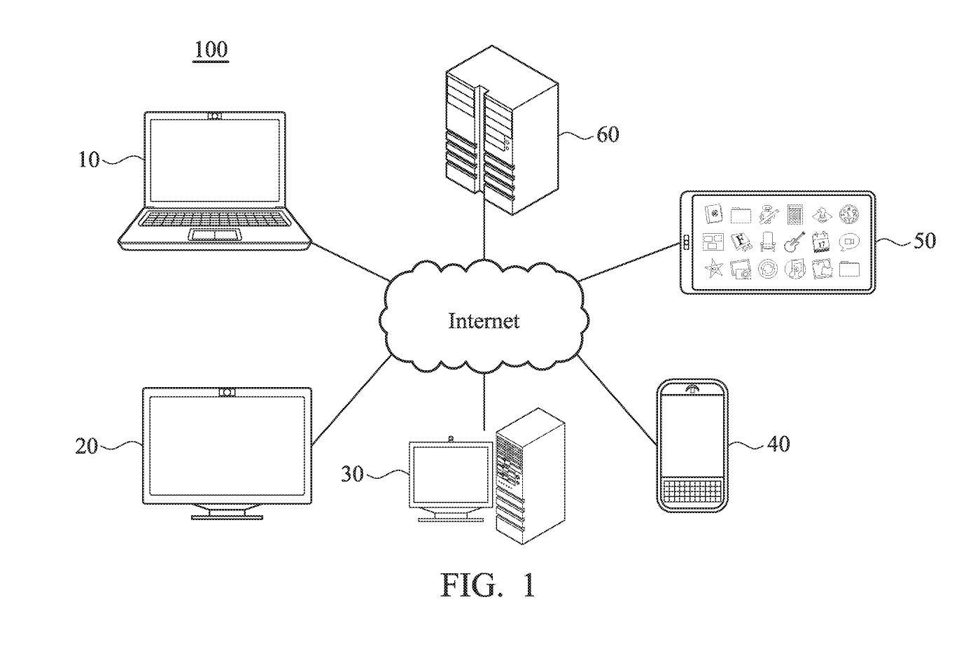

FIG. 1 is a block diagram illustrating a cloud computing environment according to an embodiment of the invention. The cloud computing environment 100 comprises the network communication devices 10 to 50 and the cloud server 60, wherein the cloud server 60 may be a remote server which is capable of network communications and is used for storing, maintaining, and managing electronic files. Particularly, the cloud server 60 is assigned with a public Internet Protocol (IP) address for users around the world to register and access via the Internet. The network communication devices 10 to 50 may be any computing devices capable of network communications. As shown in FIG. 1, a user may operate the network communication device 10 (depicted as a notebook PC), the network communication device 20 (depicted as an All-In-One (AIO) PC), the network communication device 30 (depicted as a desktop PC), the network communication device 40 (depicted as a smart phone), or the network communication device 50 (depicted as a panel PC), to access the cloud server 60 with the network access provided. Also, the user may operate one of the network communication devices 10 to 50 to register to the cloud server 60 for storing electronic files, such as video files, audio files, image files, and documentation files, etc., in sync with the cloud server 60. That is, the electronic files are stored both in the cloud server 60 and one of the network communication devices 10 to 50, and the user operation on the electronic files in one of the network communication devices 10 to 50 will be updated to the cloud server 60 for file syncing.

In another embodiment, the cloud server 60 may be installed in a private local network of an indoor environment, such as home or office, and the network communication devices 10 to 50 may first connect to the private local network via the Internet and then access the cloud server 60 therethrough.

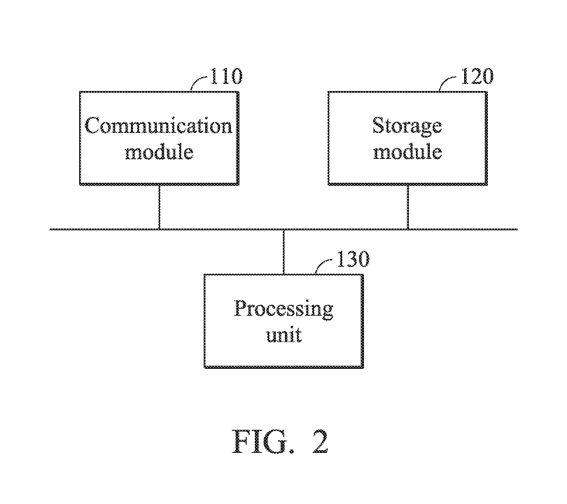

FIG. 2 is a block diagram illustrating the system architecture of a network communication device according to an embodiment of the invention. Please note that, the system architecture may be applied to any one of the network communication devices 10 to 50. The communication module 110 is configured to provide network accesses in compliance with at least one communication standard, such as Ethernet, Wireless Fidelity (Wi-Fi), Worldwide Interoperability for Microwave Access (WiMAX), Global System for Mobile communications (GSM), Wideband Code Division Multiple Access (WCDMA), or Long Term Evolution (LTE), etc. The storage module 120 may be a volatile memory (e.g., Random Access Memory (RAM)), a non-volatile memory (e.g., Flash memory), a hard disc, an optical disc, or any combination thereof, for storing electronic files and program code of an operating system and a file tracking system, wherein all or part of the electronic files are stored in sync with the cloud server 60. The processing unit 130 may be a general-purpose processor or a Micro-Control Unit (MCU) for controlling the operation of the communication module 110 and executing machine readable instructions, such as the program code of the operating system and the file tracking system, from the storage module 120 to carry out the file tracking method of the invention.

Although not shown, in other embodiments, the system architecture of the network communication device may further comprise an interface module (not shown) which provides a Man Machine Interface (MMI) for users to operate the network communication device, and the interface module may include a display screen, a keyboard, a keypad, a speaker, and/or a microphone, etc.

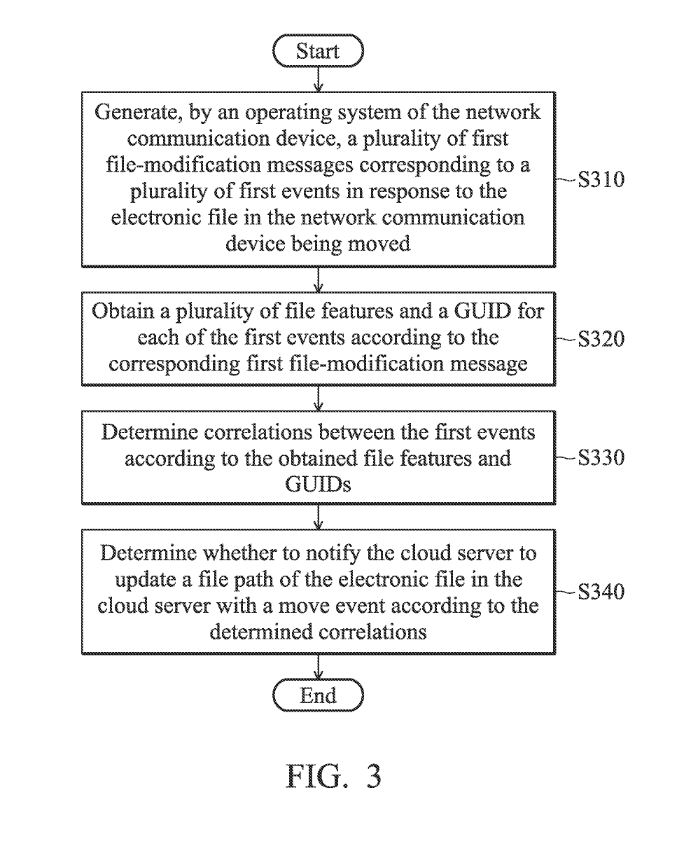

FIG. 3 is a flow chart illustrating the file tracking method according to an embodiment of the invention. Please note that, the file tracking method may be applied to a network communication device for managing at least an electronic file stored in sync with a cloud server. To begin, a plurality of first file-modification messages corresponding to a plurality of first events are generated by an operating system of the network communication device, in response to the electronic file in the network communication device being moved (step S310). Next, a plurality of file features and a Globally Unique Identification (GUID) for each of the first events are obtained according to the corresponding first file-modification message (step S320). Specifically, the file features may include the last written time, the file size, the file name, and the file extension of the electronic file in the network communication device. The GUID may be the concatenation of the last written time, the file size, the file name, and the file extension of the electronic file in the network communication device, and the GUID may be used as the basis for determining whether the first events correlate to the same electronic file.

After that, the correlations between the first events are determined according to the obtained file features and GUIDs (step S330), and then it is determined whether to notify the cloud server to update a file path of the electronic file in the cloud server with a move event according to the determined correlations (step S340). Particularly, in step S330, the notification for the cloud server to update the file path of the electronic file therein with the move event may be performed in response to the determined correlations indicating that the movement of the electronic file in the network communication device has finished. Therefore, the movement of the electronic file in the network communication device does not appear to be two independent and irrelevant file modifications (i.e., an electronic file being deleted and another electronic file being created), and users can be aware of how the electronic file was moved.

In addition to the handling of file movement as described above, the file tracking method of the invention may also handle movements of directories (also called folders) which contain electronic files in sync with the cloud server. Specifically, the handling of a directory movement comprises the steps of: generating a plurality of second file-modification messages corresponding to a plurality of second events in response to the directory of the electronic file in the network communication device being moved, obtaining a directory name and a directory path for each of the second events according to the corresponding second file-modification message, and determining whether to notify the cloud server to update the directory path of the directory in the cloud server with another move event according to the obtained directory names and directory paths, and the previous directory path of the directory in the network communication device. Particularly, the notification for the cloud server to update the directory path of the directory therein with the move event may be performed in response to the directory names corresponding to the second events being the same, and one of the second events being a delete event and its corresponding directory path being the same as the previous directory path.

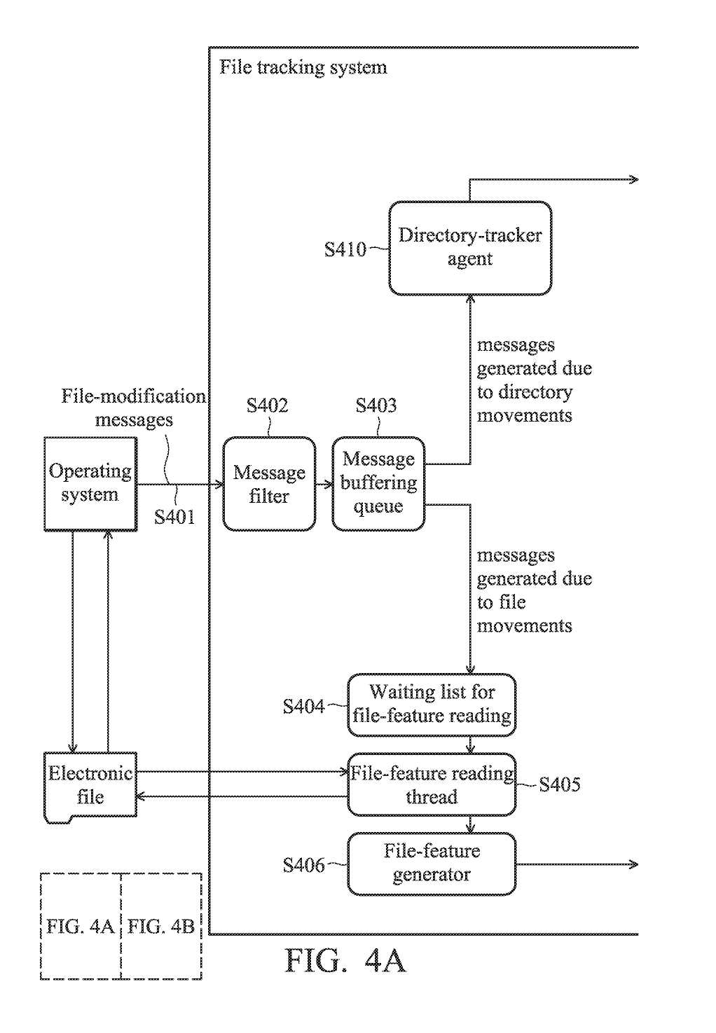

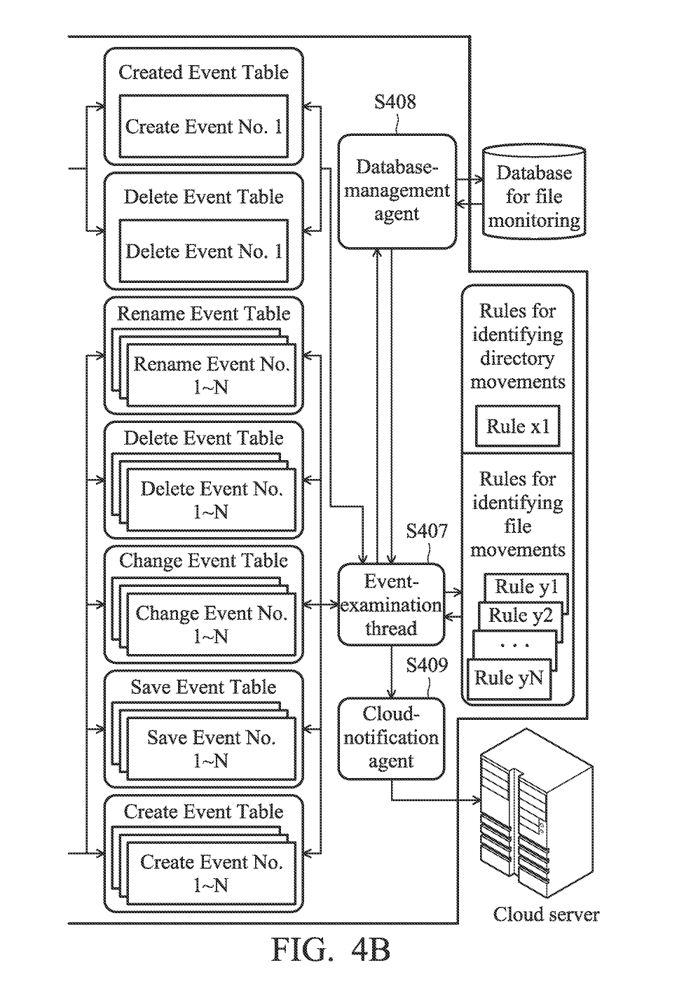

FIGS. 4A and 4B show a schematic diagram illustrating the operation of the file tracking system according to an embodiment of the invention. In an architectural aspect, the operating system and the file tracking system as shown in FIGS. 4A and 4B may be executed in a single network communication device (e.g., one of the network communication devices 10 to 50), and the electronic files monitored/managed by the file tracking system may be stored in the network communication device and maintained in sync with a cloud server. That is, the electronic files are stored in sync between the network communication device and the cloud server, and any status updates of the electronic files in the network communication device will be reflected to the cloud server.

To begin, the operating system generates a plurality of file-modification messages and transmits the file-modification messages to the file tracking system, in response to an electronic file in the network communication device being moved or the directory of the electronic file in the network communication device being moved (step S401). Specifically, a plurality of events may be generated for the file movement or the directory movement, and a respective file-modification message may be generated for each event. Particularly, for the file movement, the corresponding events may be generated due to a series of operations concerning the file movement, including the events generated for saving the electronic file prior to moving the electronic file. For example, the electronic file may be written out to a temporary file before being moved, and then the temporary file may be written in to the target file path, wherein the write-out and write-in operations may each result in a plurality of events for indicating statuses of the operations. The events related to file moving may include: create events, delete events, and change events, and the events related to file saving may include: rename events, delete events, save events, and create events, etc. In addition, operations, such as creating an electronic file in the target file path, and deleting the electronic file in the source file path (the order of the creating operation and the deleting operation may vary depending on the sectors to which the source and target file path belongs), may be involved at the beginning of the file movement, and several events may be generated for the creating operation and the deleting operation.

When the file tracking system receives the file-modification messages, the message filter determines whether the file-modification messages are required to be processed by the file tracking system (step S402). Specifically, the message filter may filter out the file-modification messages which are generated for electronic files or directories not in sync with the cloud server, i.e., the file tracking system only processes the file-modification messages which are generated for electronic files or directories in sync with the cloud server. Next, the filtered file-modification messages are stored in the message buffering queue (step S403), and then the file-modification messages are retrieved from the message buffering queue for subsequent processing according to their message types (i.e., by determining whether the message types indicate that the file-modification messages are generated due to file movements or directory movements).

For the file-modification messages generated due to file movements, the file tracking system retrieves the file-modification messages from the message buffering queue and stores them in the waiting list for file-feature reading (step S404), and then lets a file-feature reading thread continuously read out file information of the electronic file from the file-modification messages in the waiting list (step S405). When complete file information has been read out or the electronic file related to the file-modification messages cannot be found, the file-feature reading thread passes the file information to the file-feature generator (step S406). The file-feature generator obtains the file features from the file information, generates a GUID according to the file features, and then stores the file features and the GUID as an independent event in the corresponding event table.

Exemplary file features are given below in Table 1.

TABLE 1

| File features | Meaning |
|---|---|
| File Path | Path of the electronic file |
| File Size | Size of the electronic file |
| File Last Access Time | Last time of the electronic file being |
| | accessed |
| File Last Write Time | Last time of the electronic file being |
| | written |
| File Extension Name | Extension of the electronic file |
| File Name | Name of the electronic file |
| File Thumbnail | Thumbnail of the electronic file |
| File Exist | Whether the electronic file exists or not |
| File Old Path | Previous path of the electronic file before |
| | rename |
| File Old Name | Previous name of the electronic file before |
| | rename |
| File Old Extension Name | Previous extension of the electronic file |
| | before rename |
| File Event Save Complete | Whether the electronic file has been saved |

In one embodiment, the GUID may be the concatenation of the file features—“File Last Write Time”, “File Size”, “File Name”, “File Extension Name” from Table 1, and may be used for identifying which events are generated for the same electronic file. Please note that, the GUID may be the concatenation of one or more of other file features from Table 1, as long as the GUID may be used for identification purposes, and the invention is not limited thereto.

As shown in FIG. 4B, different events may be stored in different event tables according to their event types, such as rename events, delete events, change events, save events, and create events, etc. Specifically, a file movement may involve a series of operations of the operating system, including creating a temporary file in response to the user requests for saving a source file (i.e., a create event), writing out the data in the source file to the temporary file (i.e., a change/delete/rename event), writing in the data in the temporary file to a new file (i.e., a change event), and deleting or renaming the temporary file (i.e., a delete/rename event), wherein each of the file creation, the data write-out, and the file deletion may be performed several times (depending on the version of the file-editing software in use, e.g., Microsoft® Office) until all data of the source file has been written out to the new file, i.e., several temporary files may be involved during the operations.

In addition to the file features and the GUID, the file information carried by each event may further comprise a “File Index”, an “Event Create Time”, an “Event Life Time”, and an “Event Time Out”, wherein the “File Index” represents the serial number of the event in an event table, the “Event Create Time” represents the time when the event is created, the “Event Life Time” represents the elapsed time since the event was created, and the “Event Time Out” indicates whether the event has timed out.

After that, the file tracking system lets an event-examination thread use the rules specified for identifying file movements to examine the stored events in the event tables for file movements (step S407), so as to determine the correlations between the events. If the examination result (i.e., the correlations between the events) indicates that the file movement has finished, the event-examination thread notifies the local (i.e., in the network communication device) database-management agent (step S408), to update the locally maintained database for file monitoring, and notifies the cloud server, via the cloud-notification agent, to update the file path of the electronic file in the cloud server with a move event (step S409). The database-management agent and the cloud-notification agent may each be implemented as a software program or function, and the database for file monitoring is used for storing information of a list of electronic files which are stored in sync with the cloud server. In one embodiment, the database for file monitoring may be implemented as a structured parameter or a configuration file in INI format.

The rules specified for identifying file movements may vary depending on the version of the file-editing software in use. For example, the operations of file movement in Microsoft® Office 2003/2005 and 2007/2010 are different, and thus different file-modification messages are generated therefrom, wherein the events corresponding to the file-modification messages and the information carried by the events are different. Therefore, different rules may be specified for identifying file movements according to the version of the file-editing software in use. In one embodiment, a rule may be specified for identifying that an electronic file has been saved, when the event-examination thread determines that a rename event and a save event have the same GUID and the file paths in the rename event and the save event are the same. In another embodiment, a rule may be specified for identifying that an electronic file has been moved, when the event-examination thread determines that a delete event and a create event have the same GUID and the file paths in the delete event and the create event are different. In yet another embodiment, a rule may be specified for identifying that an electronic file has been moved, when the event-examination thread determines that a change event and a delete event have the same GUID and the file paths in the change event and the delete event are different.

Subsequent to step S403, for the file-modification messages generated due to directory movements, the directory-tracker agent generates the events corresponding to the file-modification messages (step S410), and then stores the events in the event tables for directory movements according to their event types. The directory-tracker agent may be implemented as a software program or function. The events generated for directory movements are simpler than the events generated for file movements, due to the event types of the events generated for directory movements including create events and delete events. The information carried by each event generated for directory movements may comprise a directory name and a directory path. Specifically, the operations of a directory movement include: creating a new directory in the target path (i.e., a create event), and deleting the old directory (i.e., a delete event). In addition, the operations of a directory movement may further include moving the electronic files from the old directory to the new directory, or changing the file paths of the electronic files in the old directory to file paths under the new directory. The detailed description regarding the operations of file movements is similar to steps S404 to S409, and is omitted herein for brevity.

Subsequently, similar to steps S407 to S409, the file tracking system lets the event-examination thread use the rules specified for identifying directory movements to examine the stored events in the event tables for directory movements, so as to determine the correlations between the events. If the examination result (i.e., the correlations between the events) indicates that the directory movement has finished, the event-examination thread notifies the database-management agent to update the database for file monitoring, and notifies the cloud server, via the cloud-notification agent, to update the directory path of the directory in the cloud server with a move event.

In one embodiment, a rule may be specified for identifying that a directory has been moved, when the event-examination thread determines that the directory names in a create event and a delete event are the same, and that the directory corresponding to the directory path in the create event exists while the directory corresponding to the directory path in the delete event does not exist, and that the directory path in the delete event is kept in the database for file monitoring (i.e., the directory path in the delete event is the same as the directory path of the directory before being moved).

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A network communication device, comprising:
a communication module, configured to provide network access to a cloud server storing at least one electronic file;
a storage module, configured to store program code of an operating system and a file tracking system, and store the electronic file in sync with the cloud server; and
a processing unit, configured to load and execute the program code to enable operations of the operating system and the file tracking system,
wherein the operations of the operating system comprise: generating a plurality of first file-modification messages corresponding to a plurality of first events in response to the electronic file in the storage module being moved, and
wherein the operations of the file tracking system comprise: obtaining a plurality of file features and a Globally Unique Identification (GUID) for each of the first events according to the corresponding first file-modification message, determining correlations between the first events according to the obtained file features and GUIDs, and determining whether to notify the cloud server via the communication module to update a file path of the electronic file in the cloud server with a move event according to the determined correlations.

2. The network communication device of claim 1, wherein the notification for the cloud server to update the file path of the electronic file therein with the move event is performed in response to the determined correlations indicating that the movement of the electronic file in the storage module has finished.

3. The network communication device of claim 1, wherein the operations of the operating system further comprise: generating a plurality of second file-modification messages corresponding to a plurality of second events in response to a directory of the electronic file in the storage module being moved, and the operations of the file tracking system further comprise: obtaining a directory name and a directory path for each of the second events according to the corresponding second file-modification message, and determining whether to notify the cloud server via the communication module to update the directory path of the directory in the cloud server with another move event according to the obtained directory names and directory paths, and a previous directory path of the directory in the storage module.

4. The network communication device of claim 3, wherein the notification for the cloud server to update the directory path of the directory therein with the move event is performed in response to the directory names corresponding to the second events being the same, and one of the second events being a delete event and its corresponding directory path being the same as the previous directory path.

5. The network communication device of claim 1, wherein the file features comprise:
a last written time of the electronic file in the storage module;
a file size of the electronic file in the storage module;
a file name of the electronic file in the storage module; and
a file extension of the electronic file in the storage module.

6. The network communication device of claim 5, wherein the GUID is a concatenation of the last written time, the file size, the file name, and the file extension of the electronic file in the storage module, and is used as a basis for determining whether the first events correlate to the same electronic file.

7. A file tracking method for a network communication device to manage at least one electronic file in sync with a cloud server, comprising:
generating, by an operating system of the network communication device, a plurality of first file-modification messages corresponding to a plurality of first events in response to the electronic file in the network communication device being moved;
obtaining a plurality of file features and a Globally Unique Identification (GUID) for each of the first events according to the corresponding first file-modification message;
determining correlations between the first events according to the obtained file features and GUIDs; and
determining whether to notify the cloud server to update a file path of the electronic file in the cloud server with a move event according to the determined correlations.

8. The file tracking method of claim 7, wherein the notification for the cloud server to update the file path of the electronic file therein with the move event is performed in response to the determined correlations indicating that the movement of the electronic file in the network communication device has finished.

9. The file tracking method of claim 7, further comprising:
generating, by the operating system of the network communication device, a plurality of second file-modification messages corresponding to a plurality of second events in response to a directory of the electronic file in the network communication device being moved;
obtaining a directory name and a directory path for each of the second events according to the corresponding second file-modification message; and
determining whether to notify the cloud server to update the directory path of the directory in the cloud server with another move event according to the obtained directory names and directory paths, and a previous directory path of the directory in the network communication device.

10. The file tracking method of claim 9, wherein the notification for the cloud server to update the directory path of the directory therein with the move event is performed in response to the directory names corresponding to the second events being the same, and one of the second events being a delete event and its corresponding directory path being the same as the previous directory path.

11. The file tracking method of claim 7, wherein the file features comprise:
a last written time of the electronic file in the network communication device;
a file size of the electronic file in the network communication device;
a file name of the electronic file in the network communication device; and
a file extension of the electronic file in the network communication device.

12. The file tracking method of claim 11, wherein the GUID is a concatenation of the last written time, the file size, the file name, and the file extension of the electronic file in the network communication device, and is used as a basis for determining whether the first events correlate to the same electronic file.
